(19) United States
(12) Patent Application Publication
(10) Pub. No.: US 2002/0089792 A1
(43) Pub. Date: Jul. 11, 2002

(54) Rotating drum and magnetic tape drive using the same

(76) Inventors: Masayuki Kondo, Kanagawa (JP); Tadashi Ozue, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/023,840

(22) Filed: Dec. 21, 2001

(30) Foreign Application Priority Data
Dec. 27, 2000 (JP) P2000-398729

(51) Int. Cl. G11B 5/52

(52) U.S. Cl. 360/271.5

(57) ABSTRACT

A rotating drum includes a magnetic head, a head base, and a holding member. The magnetic head is attached to the holding member which is attached to the head base while the magnetic head is in resilient contact with the top of a conical projection integrated with an end face of the head base, whereby the magnetic head is supported by the rotating drum via the head base.

### BACKGROUND OF THE INVENTION

1. Field of the Invention

The present invention relates to a rotating drum and a magnetic tape drive. More specifically, the present invention relates to a technique for uniformizing a contact pressure of a tape against a magnetic head by allowing the position of the magnetic head with respect to a rotor to conform to the contact state of the tape so as to prevent degradation and variation of the output during a magnetic recording/playback.

2. Description of the Related Art

FIG. 1 illustrates a rotating drum and is used also for describing an embodiment of the present invention later. The parenthetic alphabets in the Figure correspond to a known art.

The rotating drum (a) includes a stator (b) fixed to a chassis (not shown) and a rotor (c) having the substantially same outer diameter as that of the stator (b).

The rotor (c) is fixed to a rotary shaft (not shown) which is rotatable with respect to the stator (b) and faces the stator (b) with a predetermined space therebetween. The rotary shaft is rotated by a motor (not shown).

On the lower periphery of the rotor (c), a plurality of magnetic heads (d) are spaced in the circumferential direction such that the magnetic heads (d) slightly protrude from the peripheral surface of the rotor (c).

Also, each of the magnetic heads (d) is attached to a head base (e) (see FIG. 2) and the head bases (e) are fixed to and held by arbitrary portions of the rotor (c) (see FIG. 3).

On the outer peripheral surface of the stator (b), a stepped rim (f) extends spirally and the magnetic tape (g) runs by winding on the rotating drum (a), with the lower edge thereof being guided by the stepped rim (f) (see FIG. 1).

When tape loading is performed on the rotating drum (a), the magnetic tape (g) is wound on the rotating drum (a) by a predetermined angle so that a tape path is defined and the magnetic tape (g) runs in a predetermined direction, while the rotor (c) rotates.

The magnetic heads (d) receive a moderate contact pressure from the magnetic tape (g), thereby forming a track extending in an inclined direction with respect to the running direction of the magnetic tape (g) so as to record a signal, or scanning the track so as to read the signal.

Incidentally, in the above-described rotating drum (a), since the magnetic heads (d) are provided such that they are protruded from the peripheral surface of the rotating drum (a), the magnetic tape (g) wound on the rotating drum (a) is locally deformed outward (tent-shaped) at the portions which are in contact with the magnetic heads (d) (see FIGS. 1, 3, and 4).

This is inevitable in a contact-type magnetic tape drive. However, attempts are being made to lessen the protrusion of the magnetic head (d) and reduce the tension of the magnetic tape (g) to prevent abrasion of the magnetic head (d) and damage of the magnetic tape (g).

However, the area in which the magnetic head (d) is in moderate contact with the magnetic tape (g) is narrowed by lessening the protrusion of the magnetic head (d) (see FIG. 5) and reducing the tension of the magnetic tape (g), and thus increasing the attachment accuracy of the magnetic head (g) is required.

Also, in recent years, the rotating speed of the rotating drum (a) is being increased to achieve a high recording density and a high-speed process. Accordingly, accelerating the speed of the magnetic tape (g) relative to the magnetic head (d) is required.

In such a situation, the following problems occur. An airflow between the rotating drum (a) and the magnetic tape (g) causes a distortion in a tent-shaped portion created by the contact of the magnetic head (d) and the magnetic tape (g), whereby the contact pressure at the gap position on the surface of the magnetic head (d) (the center of the magnetic head) is reduced or a small space is created (spacing). Accordingly, nonuniform contact pressure occurs between the magnetic tape (g) and the magnetic head (d) (see FIG. 6) and degradation and variation of the output during recording or playback are caused.

Although the rotating drum (a) in the known art is shown using an upper drum rotating type, the above-described problems may be included in any types of drum such as a lower drum rotating type or a middle drum rotating type.

### SUMMARY OF THE INVENTION

Accordingly, it is an object of the present invention to uniformize the contact pressure of a magnetic tape against a magnetic head and eliminate a variation in the contact pressure at the gap position (the center of the magnetic head (d)), thereby preventing degradation and variation of the output during magnetic recording or playback.

In order to solve the above-described problems, the rotating drum of the present invention comprises a magnetic head; a head base; and a holding member, wherein the magnetic head is attached to the holding member which is attached to the head base and the magnetic head is in contact with the head base at least at one point, whereby the magnetic head is supported by the rotating drum via the head base.

Also, a magnetic tape drive of the present invention comprises a rotating drum including a rotor provided with a magnetic head and on which a magnetic tape is wound by a predetermined angle; guide pins for drawing the magnetic tape from a cassette tape and winding the drawn magnetic tape on the rotating drum so as to define a predetermined tape path; a pair of reel holders for supporting a pair of reels of the cassette tape; a pinch roller; and a capstan which cooperates with the pinch roller to transfer the magnetic tape. The magnetic head is attached to a holding member which is attached to a head base, and the magnetic head is in contact with the head base at least at one point, whereby the magnetic head is supported by the rotating drum via the head base.

Accordingly, when a nonuniform contact pressure is caused between the magnetic head and the magnetic tape, the magnetic head is inclined according to a strong contact pressure, that is, the magnetic head conforms to the variation in the contact pressure because the rear face of the magnetic head is in contact with the head base at least at one point. Therefore, the contact pressure at the gap position of the magnetic head does not vary and degradation and variation of the output during recording or playback can be prevented.

Preferably, the holding member has a resilient force and the magnetic head is in resilient contact with the head base. With this arrangement, since the magnetic head has the tendency to revert to the original position when it is inclined, the flexibility to the variation in the contact pressure between the magnetic tape and the magnetic head is increased.

Preferably, the supporting point of the head base for the magnetic head is a pivot point. With this arrangement, the position of the magnetic head can be changed to some extent in the direction orthogonal to the running direction of the magnetic tape, that is, in a vertical direction. Thus, the magnetic head can contribute to achieving the uniform contact pressure in the vertical direction. Accordingly, the position of the magnetic head on the rotating drum in the width direction of the magnetic tape is different at the position where the magnetic tape comes into and leaves contact with the rotating drum and thus a nonuniform contact pressure between the magnetic tape and the magnetic head occurs in the vertical direction, but this nonuniformity can be overcome.

### BRIEF DESCRIPTION OF THE DRAWINGS

FIG. 1 is a schematic perspective view of a rotating drum according to a first embodiment of the present invention;

FIG. 2 is an enlarged perspective view showing an attachment of a head base and a magnetic head of a known art;

FIG. 3 is an enlarged sectional view of a critical part of a rotating drum of the known art;

FIG. 4 is a schematic plan view in which a contact pressure between the magnetic head and a magnetic tape is uniform and is for illustrating a problem in the known art;

FIG. 5 is a schematic plan view for illustrating a problem which occurs when the protrusion of the magnetic head is lessened in the known art;

FIG. 6 is a schematic plan view showing the state in which a nonuniform contact pressure is caused in the known art;

FIG. 7 is a plan view schematically shows an overview of a magnetic tape drive of the present invention;

FIG. 8 is an enlarged sectional view of a critical portion of the rotating drum according to the first embodiment;

FIG. 9 is an enlarged perspective view showing an attachment of a head base and a magnetic head of the first embodiment;

FIG. 10 is an exploded perspective view showing the attachment of the head base and the magnetic head of the first embodiment;

FIG. 11 is a plan view showing the attachment of the head base and the magnetic head of the first embodiment;

FIG. 12 is a schematic plan view for illustrating a state in which a nonuniform contact pressure is caused;

FIG. 13 illustrates a state in which the nonuniform contact pressure is overcome by a function of the present invention;

FIG. 14 is an exploded perspective view showing an attachment of a head base and a magnetic head according to a second embodiment;

FIG. 15 is a plan view showing the attachment of the head base and the magnetic head according to the second embodiment; and

FIG. 16 is an exploded perspective view of a head base and a magnetic head and shows a modification of projections provided in the head base.

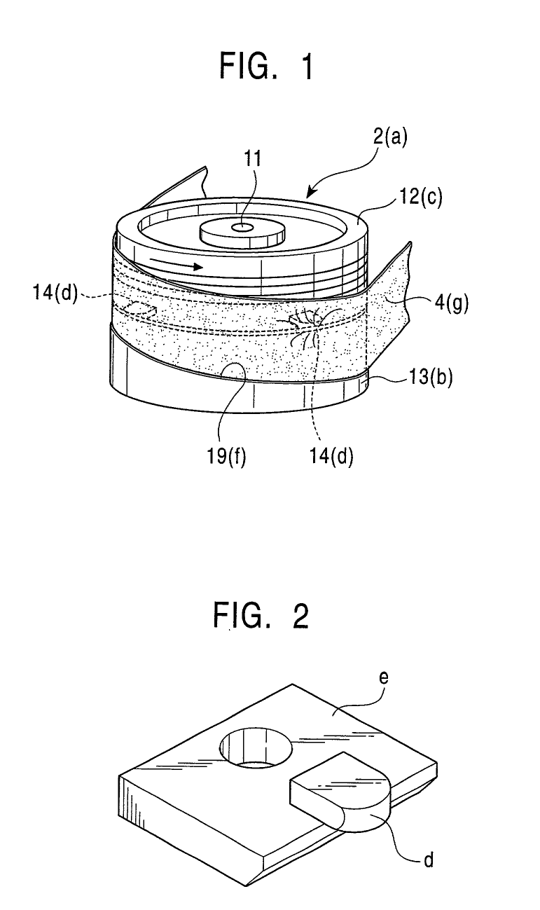

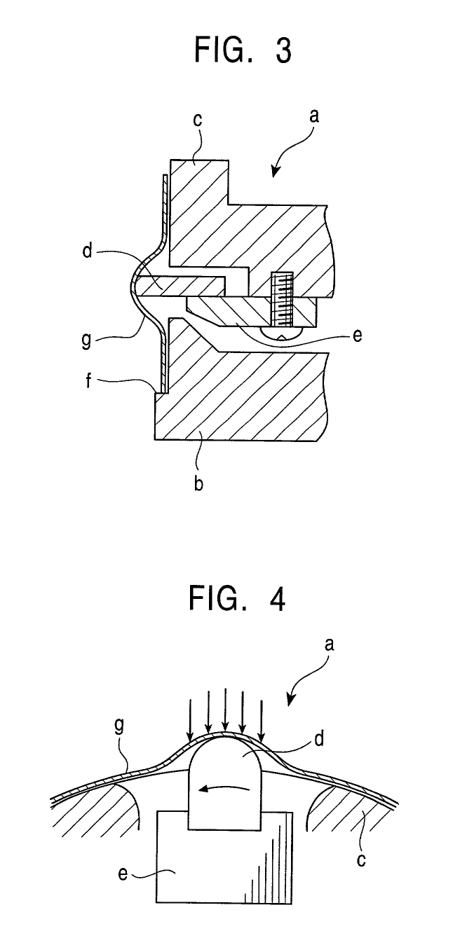

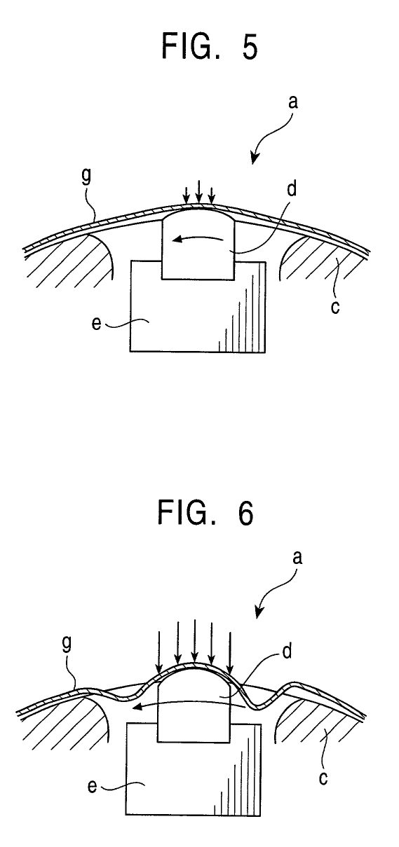

### DESCRIPTION OF THE PREFERRED EMBODIMENTS

Hereinafter, the present invention is described in detail in accordance with embodiments shown in the accompanying drawings.

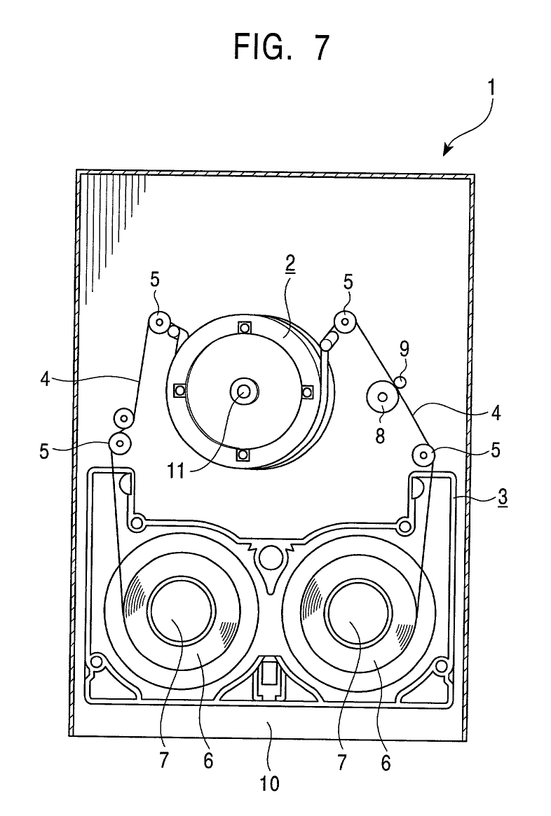

First, an overview of a magnetic tape drive is described with reference to FIG. 7.

The magnetic tape drive 1 includes a rotating drum 2, guide pins 5 for drawing a magnetic tape 4 from a cassette tape 3 and winding the drawn magnetic tape 4 on the rotating drum 2 so as to define a predetermined tape path, a pair of reel holders 7 for supporting a pair of reels 6 of the cassette tape 3, a pinch roller 8, and a capstan 9 cooperating with the pinch roller 8 to transfer the magnetic tape 4 (see FIG. 7).

The rotating drum 2 of the magnetic tape drive 1 is placed such that the axis thereof is slightly inclined with respect to the chassis 10. When the cassette tape 3 is loaded in a cassette holder, the magnetic tape 4 is drawn toward the rotating drum 2 by the guide pins 5 and wound on the rotating drum 2, while the magnetic tape 4 is pinched by the pinch roller 8 and the capstan 9 so that the tape path is defined (see FIG. 7).

FIG. 7 schematically shows a state in which the cassette tape 3 is loaded in the magnetic tape drive 1 and the tape path is defined.

When the tape path is defined, the rotating drum 2 and the capstan 9 rotate so that the magnetic tape 4 runs at a constant rate.

The rotating drum 2 includes a fixed shaft 11 provided on the chassis 10, a rotor 12 rotatably supported by the fixed shaft 11 via a bearing (not shown), and a stator 13 located below the rotor 12 and fixed to the chassis 10. The rotor 12 and the stator 13 face each other with a predetermined space therebetween. On the lower periphery of the rotor 12, a plurality of magnetic heads 14 are spaced in the circumferential direction such that the magnetic heads 14 slightly protrude from the peripheral surface of the rotor 12 (see FIG. 1).

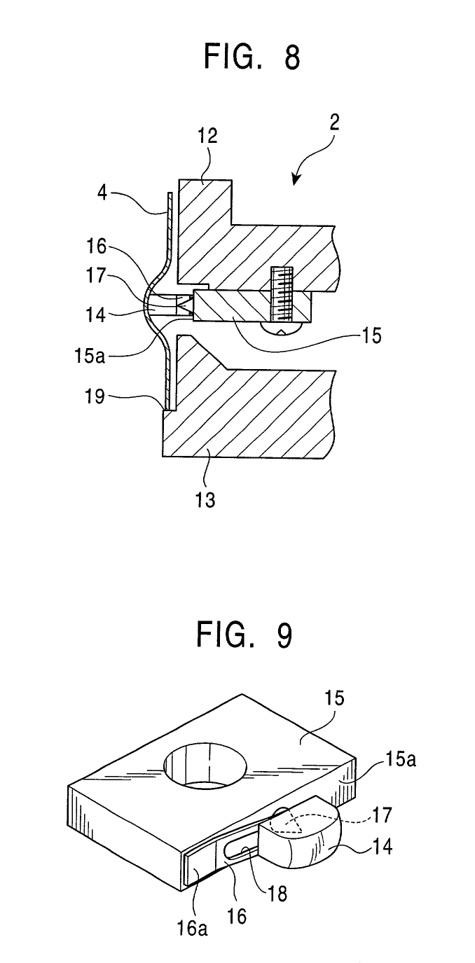

Further, each of the magnetic heads 14 is held by a head base 15 via a flat spring 16 which functions as a holding member. The head bases 15 are fixed to arbitrary portions of the rotor 12 so that each of the magnetic heads 14 is held by the rotor 12 (see FIG. 8).

Now, the attachment of the magnetic head 14 will be described more specifically with reference to FIGS. 9 to 11. A conical projection 17 is provided at the center of an end face 15a of the head base 15. One end (base end) 16a of the flat spring 16 is fixed to one side of the end face 15a of the head base 15 and the other end 16b extends toward the other side of the end face 15a of the head base 15. Also, an oval window 18, through which the conical projection 17 penetrates, is provided in the center of the flat spring 16 (see FIG. 9).

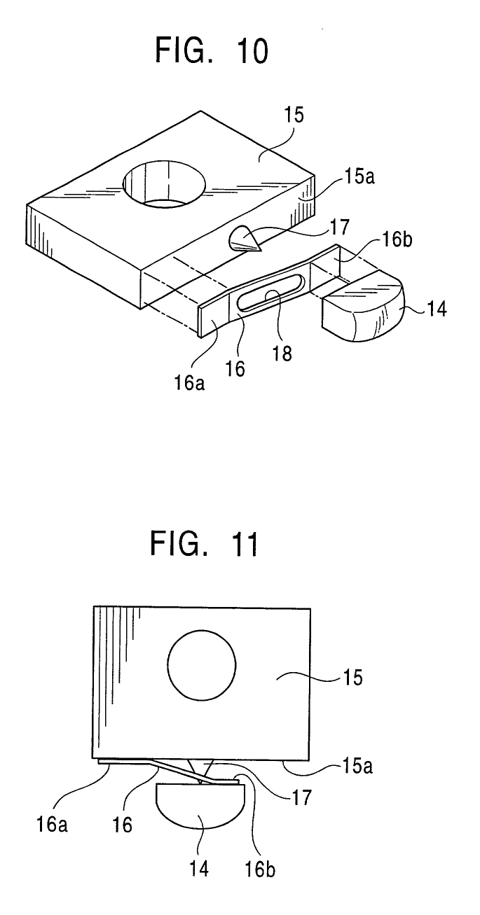

Also, one side of the rear face of the magnetic head 14 is attached to the end 16b of the flat spring 16 such that the magnetic head 14 is located in substantially the center the head base 15. Further, the flat spring 16 urges the magnetic head 14 to the head base 15 so that the substantially center portion of the rear face of the magnetic head 14 is in resilient contact with the top of the conical projection 17 (see FIGS. 10 and 11).

On the outer peripheral surface of the stator 13, a stepped rim 19 extends spirally and the magnetic tape 4 runs by winding on the rotating drum 2, with the lower edge thereof being guided by the stepped rim 19 (see FIG. 1).

When tape loading is performed on the rotating drum 2, the magnetic tape 4 is wound on the rotating drum 2 by a predetermined angle so that the tape path is defined and the magnetic tape 4 runs in a predetermined direction. Also, the rotor 12 rotates and the magnetic heads 14 form a track extending in an inclined direction with respect to the running direction of the magnetic tape 4 so as to record a signal, or the magnetic heads 14 scan the track so as to read the signal.

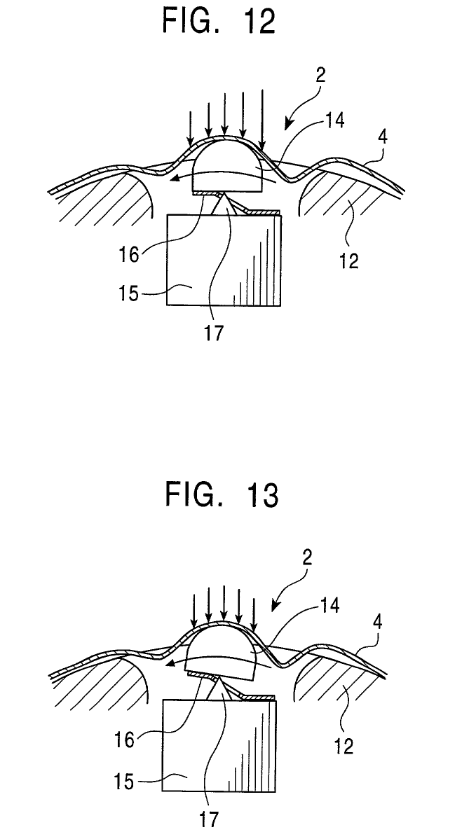

When the speed of the magnetic tape 4 relative to the magnetic head 14 is increased, an airflow between the rotating drum 2 and the magnetic tape 4 causes a distortion in a tent-shaped portion created by the contact of the magnetic head 14 and the magnetic tape 4 and the nonuniformity of the contact pressure of the magnetic tape 4 against the magnetic head 14 (see FIG. 12). In the rotating drum 2 of this embodiment, however, since the rear face of the magnetic head 14 is in contact with the head base 15 at one point, the magnetic head 14 is inclined according to a strong contact pressure, that is, the magnetic head 14 conforms to the variation in the contact pressure (see FIG. 13). Therefore, the contact pressure at the gap position of the magnetic head 14 does not vary and degradation and variation of the output during recording or playback can be prevented.

Also, since the magnetic head 14 is in resilient contact with the head base 15, the magnetic head 14 has the tendency to revert to the original position when it is inclined. Thus, the flexibility to the variation in the contact pressure between the magnetic tape 4 and the magnetic head 14 is increased.

In addition, in the rotating drum 2 of the first embodiment, since the magnetic head 14 is in contact with the head base 15 at one point, the position of the magnetic head 14 can be changed to some extent in the direction orthogonal to the running direction of the magnetic tape 4, that is, in a vertical direction. Thus, the magnetic head 14 can contribute to achieving the uniform contact pressure in the vertical direction. Accordingly, the position of the magnetic head 14 on the rotating drum 2 in the width direction of the magnetic tape 4 is different at the position where the magnetic tape 4 comes into and leaves contact with the rotating drum 2 and thus a nonuniform contact pressure between the magnetic tape 4 and the magnetic head 14 occurs in the vertical direction, but this nonuniformity can be overcome.

Further, in the rotating drum 2 of the first embodiment, the magnetic head 14 is attached to the flat spring 16 and the flat spring 16 is attached to the head base 15. Therefore, though the magnetic head 14 is in contact with the head base 15 at one point, the movement of the magnetic head 14 in the circumferential direction to the vertical axis of the contact surface of the magnetic head 14 and the magnetic tape 4 is suppressed and a stable contact between the magnetic head 14 and the magnetic tape 4 can be achieved.

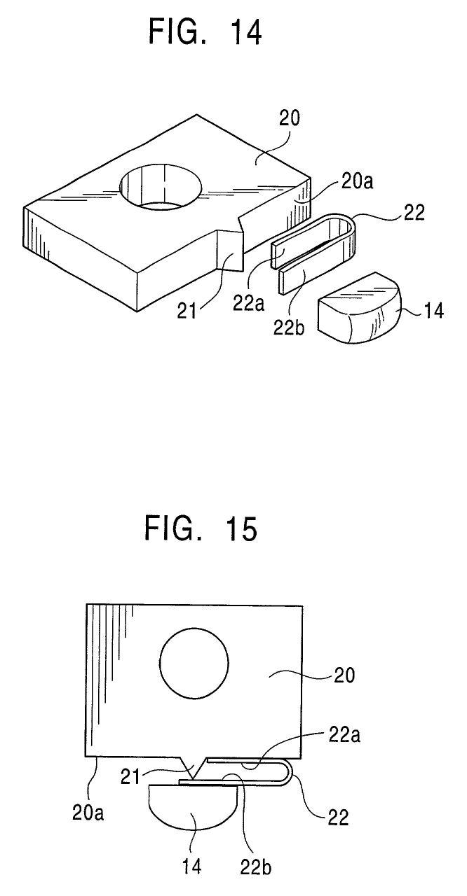

FIGS. 14 and 15 show a second embodiment of the rotating drum of the present invention. The second embodiment differs from the first embodiment in that the magnetic head is in linear contact with the head base and that the flat spring for holding the magnetic head is U-shaped. The figures show only critical portions, and only the differences are described.

A wedge-shaped projection 21 is integrated with substantially the center of an end face 20a of a head base 20. One side 22a of the U-shaped flat spring 22 is fixed to one side of the end face 20a and the other side 22b of the flat spring 22 faces the side 22a in a manner that the end of the other side 22b covers the top of the wedge-shaped projection 21 (see FIGS. 14 and 15).

The magnetic head 14 is attached to the other end 22b of the flat spring 22 and the top of the wedge-shaped projection 21 is placed at the center of the rear face of the magnetic head 14. Accordingly, the magnetic head 14 is in resilient contact with the top of the wedge-shaped projection 21 via the other side 22b of the flat spring 22.

In the rotating drum 2 according to the second embodiment, like that of the first embodiment, the tent-shaped portion at the contact position of the magnetic head 14 and the magnetic tape 4 may be deformed due to the airflow between the rotating drum 2 and the magnetic tape 4 caused by the increase in the speed of the magnetic tape 4 relative to the magnetic head 14. However, when nonuniform contact pressure of the magnetic tape 4 against the magnetic head 14 occurs, the magnetic head 14 inclines according to a strong contact pressure because the rear face of the magnetic head 14 linearly and resiliently contacts the head base 20 via the flat spring 22. That is, the magnetic head 14 can conform to the variation in the contact pressure and the contact pressure at the gap position of the magnetic head 14 does not vary, and thus degradation and variation of the output during recording or playback can be prevented.

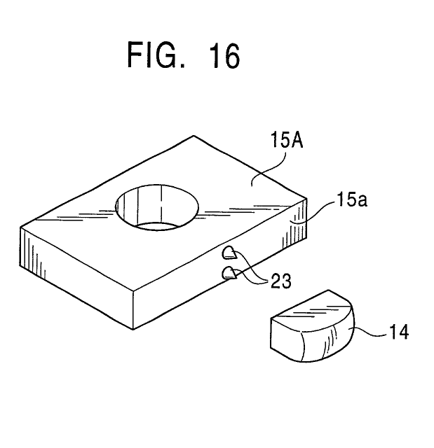

FIG. 16 shows a modification of a projection formed in the head base. In this modification, two conical projections 23 are integrated with substantially the center of an end face 15a of a head base 15A, with the two projections being spaced vertically. The flat spring according to each of the above-described embodiments may be used, although a holding member for attaching the magnetic head to the head base is not shown in FIG. 16.

The magnetic head 14 may be in linear contact with this head base 15A at two points. The magnetic head 14 supported by these two conical projections 23 inclines according to a strong contact pressure when nonuniform contact pressure of the magnetic tape 4 against the magnetic head 14 is caused as in the second embodiment. That is, the magnetic head 14 conforms to the variation of the contact pressure and the contact pressure at the gap position of the magnetic head 14 does not vary. Therefore, degradation and variation of the output during recording and playback can be prevented.

In the above-described embodiments and modification, a flat spring is used as a holding member for attaching the magnetic head to the head base. However, the present invention is not limited to the use of the flat spring and any flexible member such as a wire or rubber can be used.

In addition, the specific form and configuration of each portion in the above-described embodiments and modification are only examples for embodying the present invention and these are not intended to limit the scope of the present invention.

What is claimed is:

1. A rotating drum comprising:
a magnetic head;
a head base; and
a holding member,
wherein the magnetic head is attached to the holding member which is attached to the head base, and
the magnetic head is in contact with the head base at least at one point,
whereby the magnetic head is supported by the rotating drum via the head base.

2. The rotating drum according to claim 1, wherein the holding member has a resilient force and the magnetic head is in resilient contact with the head base.

3. The rotating drum according to claim 1, wherein the supporting point of the head base for the magnetic head is a pivot point.

4. A magnetic tape drive comprising:
a rotating drum including a rotor provided with a magnetic head and on which a magnetic tape is wound by a predetermined angle;
guide pins for drawing the magnetic tape from a cassette tape and winding the drawn magnetic tape on the rotating drum so as to define a predetermined tape path;
a pair of reel holders for supporting a pair of reels of the cassette tape;
a pinch roller; and
a capstan which cooperates with the pinch roller to transfer the magnetic tape,
wherein the magnetic head is attached to a holding member which is attached to a head base, and
the magnetic head is in contact with the head base at least at one point,
whereby the magnetic head is supported by the rotating drum via the head base.

5. The magnetic tape drive according to claim 4, wherein the holding member has a resilient force and the magnetic head is in resilient contact with the head base.

6. The magnetic tape drive according to claim 4, wherein the supporting point of the head base for the magnetic head is a pivot point.
